(19) United States
(12) Patent Application Publication
(10) Pub. No.: US 2025/0344718 A1
(43) Pub. Date: Nov. 13, 2025

(54) SLUSH MACHINE

(71) Applicant: Guangzhou Xin'an Trading Co., Ltd., Guangzhou (CN)

(72) Inventor: Kui Chen, Guangzhou (CN)

(21) Appl. No.: 19/017,765

(22) Filed: Jan. 12, 2025

(30) Foreign Application Priority Data
May 7, 2024 (CN) 202410556731.8
May 7, 2024 (CN) 202420973088.4
Sep. 10, 2024 (CN) 202411263672.1
Sep. 10, 2024 (CN) 202422225395.7

(51) Int. Cl. A23G 9/04; A23G 9/12; A23G 9/22; A23G 9/28

(52) U.S. Cl. CPC A23G 9/045; A23G 9/12; A23G 9/224; A23G 9/28

(57) ABSTRACT

The present disclosure provides a slush machine, including a fixation assembly, an enclosure assembly, a stirring assembly, a refrigeration assembly, and a discharge assembly, where the stirring assembly comprises a support rack and a stirring mechanism provided on the support rack; the stirring mechanism comprises a protective housing, a drive motor, and a scraper; the refrigeration assembly includes an evaporator; the discharge assembly includes a storage housing and a discharge cartridge; the storage housing is provided horizontally; a storage chamber is formed in the storage housing; the discharge cartridge is provided vertically and communicates with the storage chamber; the storage housing is fixed on the support rack; the evaporator and the scraper are located in the storage chamber. The present disclosure can prevent leakage of the smoothie, thereby improving the use experience.

### CROSS REFERENCE TO RELATED APPLICATIONS

The present application claims the benefit of Chinese Patent Application Nos. 202422225395.7 and 202411263672.1 filed on Sep. 10, 2024, 202420973088.4 and 202410556731.8 filed on May 7, 2024. All the above are hereby incorporated by reference in their entirety.

### TECHNICAL FIELD

The present disclosure relates to the technical field of slush machines, and in particular to a slush machine.

### BACKGROUND

As a device capable of making the smoothie, the slush machine (also called the smoothie machine) is an important part of modern kitchen appliances, and its design and performance are directly associated with the use experience and the quality of beverages. The conventional slush machine usually uses a storage housing as a container to accommodate the liquid. The liquid forms the smoothie in the storage housing. To add the liquid conveniently, a feed inlet of the storage housing is a circular structure or a square structure. However, in the icing and stirring processes, since the density of the smoothie is less than the density of the water, the total volume of the iced smoothie is increased. Meanwhile, due to high-speed rotation of the stirrer and complexity of the smoothie in flowing, the smoothie is easily poured back through the feed inlet. Especially in case of a high stirring intensity or much more solution, the leakage is particularly obvious. This affects the use experience of the slush machine seriously.

### SUMMARY

A technical problem to be solved by the present disclosure is to provide a slush machine. The slush machine can prevent leakage of the smoothie, thereby improving the use experience.

In order to solve the above-mentioned technical problem, the present disclosure provides a slush machine, including a stirring assembly, a refrigeration assembly, and a discharge assembly, where the stirring assembly includes a support rack and a stirring mechanism provided on the support rack; the stirring mechanism includes a protective housing, a drive motor, and a scraper; the refrigeration assembly includes an evaporator; the evaporator is provided on the support rack; the drive motor is connected to the scraper through the evaporator; and the protective housing is sleeved on the drive motor; and

the discharge assembly includes a storage housing and a discharge cartridge; the storage housing is provided horizontally; a storage chamber is formed in the storage housing; the discharge cartridge is provided vertically and communicates with the storage chamber; the storage housing is fixed on the support rack; the evaporator and the scraper are located in the storage chamber; a feed inlet is formed in the storage housing; a feed clapboard is provided under the feed inlet; and an elongated feed hole is formed in the feed clapboard.

As an improvement to the above solution, the protective housing is connected to the storage housing; a fixing portion is provided at a junction between the protective housing and the storage housing; the fixing portion is provided vertically; the feed clapboard is provided obliquely; the feed hole is formed in a lower position of the feed clapboard; the feed hole is formed along a length direction of the evaporator; and a longitudinal cross-section of the feed hole is gradually increased from the fixing portion to a direction away from the protective housing.

As an improvement to the above solution, the slush machine further includes a fixation assembly and an enclosure assembly; the fixation assembly includes a chassis as well as a first fixing rack and a second fixing rack provided on the chassis; the enclosure assembly includes a front vertical plate, a rear vertical plate, a first side vertical plate, and a second side vertical plate surrounding a periphery of the chassis; and the first fixing rack and the second fixing rack are respectively located at a bottom of a front end and a bottom of a rear end of the support rack, and are fixedly connected to the support rack.

As an improvement to the above solution, the refrigeration assembly further includes a condenser; the fixation assembly further includes a fixing frame; the fixing frame is provided at a side of the second fixing rack; an air duct is formed in the fixing frame; first vertical rods are respectively provided at two sides of the first fixing rack; second vertical rods are respectively provided at two sides of the second fixing rack; the condenser includes end plates; the end plates are respectively provided at an upper side and a lower side of the condenser, and are fixed on the fixing frame; and the fixing frame is fixed on the second fixing rack.

As an improvement to the above solution, vertical fixing plates are respectively provided at two sides of the fixing frame; a convex fixing plate is provided at a front side of the fixing vertical plate; a side of the convex fixing plate close to the second fixing rack is protruded; a frame fixing hole and a frame limiting fastener are provided on the convex fixing plate; a stud hole and a frame limiting hole are formed in the second vertical rod; the stud hole corresponds to the frame fixing hole; and the frame limiting fastener can be buckled into the frame limiting hole.

As an improvement to the above solution, the fixing frame further includes a frame plate and side baffles; the side baffles are respectively provided at a left side and a right side of the frame plate, and extend away from the convex fixing plate; the side baffles enclose a heat dissipation channel; condenser fixing plates are respectively provided at an upper side and a lower side of the frame plate; the end plate is fixed on the condenser fixing plate; a side of the frame plate away from the condenser is provided with a fan fixing hole and a fan limiting post; the refrigeration assembly further includes a cooling fan; and the cooling fan can be inserted into the fan limiting post and fixed on the fan fixing hole.

As an improvement to the above solution, a support flange is provided at an edge of the chassis; the support flange is protruded from an outer sidewall of the chassis; support pedestals are respectively provided at an inner bottom of the first side vertical plate and an inner bottom of the second side vertical plate; a bottom fixing hole is formed in the support pedestal; a bottom of the support flange can abut against the support pedestal; and the chassis can be fixed in the bottom fixing hole.

As an improvement to the above solution, a first vertical plate support portion is provided at an inner side of the first side vertical plate; the first vertical plate support portion is protruded toward the second side vertical plate; a first connecting hole is formed vertically in the first vertical plate support portion; a second vertical plate support portion is provided at an inner side of the second side vertical plate; the second vertical plate support portion is protruded toward the first side vertical plate; a second connecting hole is formed vertically in the second vertical plate support portion; and the first connecting hole corresponds to the second connecting hole.

As an improvement to the above solution, a side limiting hole formed horizontally and a first side fixing hole formed vertically are further provided in the first vertical plate support portion; a side limiting bump is further horizontally provided in the second vertical plate support portion; a second side fixing hole is vertically formed in and penetrates the side limiting bump; the side limiting bump can be inserted into the side limiting hole; and the first side fixing hole corresponds to the second side fixing hole.

As an improvement to the above solution, the refrigeration assembly further includes a throttle tube and an air return tube; a compressor communicates with an inlet of the condenser; the condenser communicates with the evaporator through the throttle tube; the evaporator communicates with the compressor through the air return tube; the throttle tube is arranged along the air return tube; and a middle section of the throttle tube is fixed on a middle section of the air return tube in a winding manner; and

a heat dissipation hole is formed in a bottom of the support rack; the heat dissipation hole is located under the drive motor; and both the air return tube and the throttle tube pass through the heat dissipation hole downwardly from one end of the evaporator.

As an improvement to the above solution, a bracket is further provided under the discharge cartridge; a front connecting hook is provided at one side of the bracket; a front side of the first vertical plate support portion and the second vertical plate support portion is provided with a front connecting groove; the front connecting hook can be inserted into the front connecting groove; the bracket is configured to support a smoothie container; a hanger connecting hole is further formed in a side of the first side vertical plate and/or a side of the second side vertical plate; the enclosure assembly further includes a hanger; the hanger includes one side provided with a hanging plate, and the other side provided with a connecting bump; the connecting bump is protruded from the hanging plate, and can be inserted into the hanger connecting hole; a slot is formed in a bottom of the bracket; an opening of the slot is provided downwardly; and the connecting bump can be inserted into the slot.

The present disclosure has the following beneficial effects:

According to the present disclosure, the slush machine includes a stirring assembly, a refrigeration assembly, and a discharge assembly. The stirring assembly includes a stirring mechanism. The stirring mechanism includes a protective housing, a drive motor, and a scraper. The refrigeration assembly includes an evaporator. The discharge assembly includes a storage housing and a discharge cartridge. A storage chamber is formed in the storage housing. The evaporator and the scraper are located in the storage chamber. The liquid is poured into the storage chamber, and frozen into an ice crystal mixture under an action of the evaporator. The drive motor drives the scraper to stir the ice crystal mixture to form the smoothie. A feed inlet is formed in the storage housing. A feed clapboard is provided under the feed inlet. An elongated feed hole is formed in the feed clapboard. After the liquid enters the feed inlet, the liquid comes in contact with the feed clapboard first and then enters the storage chamber from the feed hole of the feed clapboard. When the liquid is iced and the smoothie flows in the storage housing, since the feed hole is the elongated structure with a length greater than a width, the smoothie is discharged hardly from the elongated hole. Therefore, the present disclosure can prevent the leakage of the smoothie to improve the use experience.

### BRIEF DESCRIPTION OF THE DRAWINGS

FIG. 1 is a schematic view of a first breakdown structure of a slush machine according to the present disclosure;

FIG. 2 is a schematic structural view of a discharge assembly according to the present disclosure;

FIG. 3 is a schematic sectional view of a discharge assembly according to the present disclosure;

FIG. 4 is a schematic view of a second breakdown structure of a slush machine according to the present disclosure;

FIG. 5 is a schematic view of a third breakdown structure of a slush machine according to the present disclosure;

FIG. 6 is a schematic view of a breakdown structure of a first side vertical plate and a second side vertical plate according to the present disclosure;

FIG. 7 is a schematic view of a mounting structure of a throttle tube, an air return tube, and a support rack according to the present disclosure;

FIG. 8 is a schematic view of a fourth breakdown structure of a slush machine according to the present disclosure; and

FIG. 9 is a partially enlarged view of A in FIG. 8.

### DETAILED DESCRIPTION

In order to make the objectives, technical solutions, and advantages of the present disclosure clearer, the present disclosure will be further described below in detail with reference to the accompanying drawings. It should be noted that orientation terms such as “upper”, “lower”, “left”, “right”, “front”, “rear”, “inner”, and “outer” that appear or are about to appear in the present disclosure are only based on the accompanying drawings of the present disclosure, and do not specifically limit the present disclosure.

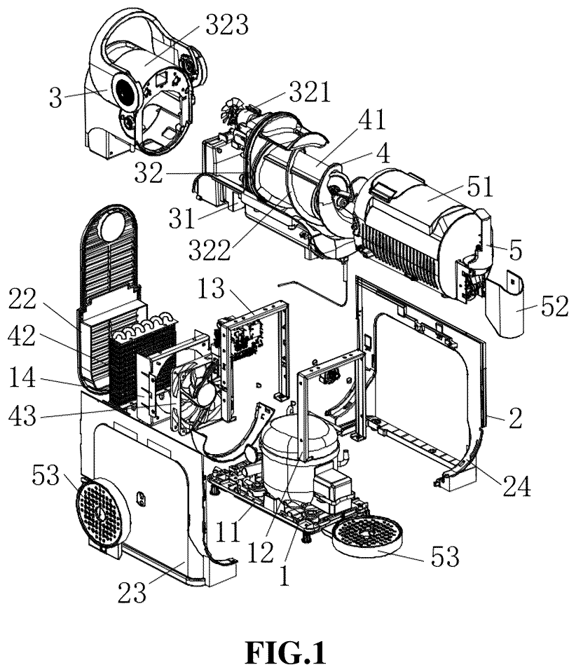

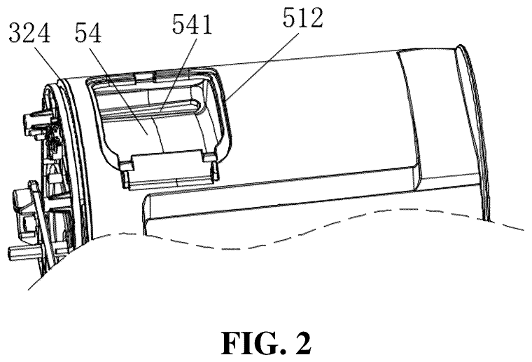

Referring to FIG. 1 and FIG. 2, an embodiment of the present disclosure provides a slush machine, including a fixation assembly 1, an enclosure assembly 2, a stirring assembly 3, a refrigeration assembly 4, and a discharge assembly 5. The fixation assembly 1 includes a chassis 11 as well as a first fixing rack 12 and a second fixing rack 13 provided on the chassis 11. The first fixing rack 12 and the second fixing rack 13 are respectively provided at a front end and a rear end of the chassis 11. The enclosure assembly 2 includes a front vertical plate (not shown in the figure), a rear vertical plate 22, a first side vertical plate 23, and a second side vertical plate 24 surrounding a periphery of the chassis 11. The first side vertical plate 23 and the second side vertical plate 24 are respectively provided at a left side and a right side of the chassis 11. The front vertical plate, the rear vertical plate 22, the first side vertical plate 23, and the second side vertical plate 24 can surround the first fixing rack 12 and the second fixing rack 13. The stirring assembly 3 includes a support rack 31 and a stirring mechanism 32 provided on the support rack 31. The support rack 31 can be configured to fix the stirring mechanism 32. The first fixing rack 12 and the second fixing rack 13 are respectively located at a bottom of a front end and a bottom of a rear end of the support rack 31, and are fixedly connected to the support rack 31. The first fixing rack 12 and the second fixing rack 13 support the support rack 31. The stirring mechanism 32 includes a protective housing 323, a drive motor 321, and a scraper 322. The refrigeration assembly 4 includes an evaporator 41. The protective housing 323 is sleeved on the drive motor 321 to protect the drive motor 321. The evaporator 41 is provided on the support rack 31. The drive motor 321 is connected to the scraper 322 through the evaporator 41. The drive motor 321 can drive the scraper 322 to perform rotary stirring on a sidewall of the evaporator 41, and can stir an ice crystal mixture formed on the sidewall of the evaporator 41 to form a smoothie.

In order to pour the liquid and discharge the smoothie, the discharge assembly 5 includes a storage housing 51 and a discharge cartridge 52. The storage housing 51 is provided horizontally. A storage chamber 511 is formed in the storage housing 51. The evaporator 41 and the scraper 322 are located in the storage chamber 511. The liquid is poured into the storage chamber 511 from the storage housing 51, and frozen under an action of the evaporator 41. The drive motor 321 drives the scraper 322 to stir the ice crystal mixture to form the smoothie. The discharge cartridge is provided vertically and communicates with the storage chamber 511. After the smoothie is formed, the discharge cartridge 52 is opened. Driven by the stirring of the scraper 322, the smoothie is discharged from the discharge cartridge 52. The storage housing 51 is fixed on the support rack. A feed inlet 512 is formed in the storage housing 51. For the conventional slush machine, the liquid is poured directly from the feed inlet 512. For ease of entry of the liquid, an opening of the feed inlet 512 is usually large. However, when the liquid is iced and the smoothie flows in the storage housing 51, the smoothie is discharged easily from the feed inlet 512 to form leakage. In view of this, a feed clapboard 54 is provided under the feed inlet 512. An elongated feed hole 541 is formed in the feed clapboard 54. The feed hole 541 is an elongated structure, with a length far greater than a width. When the liquid is poured from the feed inlet 512, the liquid does not directly enter the storage chamber 511, but comes in contact with the feed clapboard 54 first and then enters the storage chamber 511 from the feed hole 541. Under an action of the feed clapboard 54, when the liquid is iced and the smoothie flows in the storage housing 51, the feed clapboard 54 can stop the smoothie, such that the smoothie is not directly discharged from the feed inlet 512. Moreover, because of the elongated structure of the feed hole 541, the smoothie passes through the feed hole 541 hardly. Therefore, the present disclosure can prevent the leakage well to greatly improve the use experience.

The embodiment of the present disclosure has the following beneficial effects:

According to the embodiment of the present disclosure, the slush machine includes a stirring assembly 3, a refrigeration assembly 4, and a discharge assembly 5. The stirring assembly 3 includes a stirring mechanism 32. The stirring mechanism 32 includes a protective housing 323, a drive motor 321, and a scraper 322. The refrigeration assembly 4 includes an evaporator 41. The discharge assembly 5 includes a storage housing 51 and a discharge cartridge 52. A storage chamber 511 is formed in the storage housing 51. The evaporator 41 and the scraper 322 are located in the storage chamber 511. The liquid is poured into the storage chamber 511, and frozen into an ice crystal mixture under an action of the evaporator 41. The drive motor 321 drives the scraper 322 to stir the ice crystal mixture to form the smoothie. A feed inlet 512 is formed in the storage housing 51. A feed clapboard 54 is provided under the feed inlet 512. An elongated feed hole 541 is formed in the feed clapboard 54. After the liquid enters the feed inlet 512, the liquid comes in contact with the feed clapboard 54 first and then enters the storage chamber 511 from the feed hole 541 of the feed clapboard 54. When the liquid is iced and the smoothie flows in the storage housing 51, since the feed hole 541 is the elongated structure with a length greater than a width, the smoothie is discharged hardly from the elongated hole. Therefore, the present disclosure can prevent the leakage of the smoothie to improve the use experience.

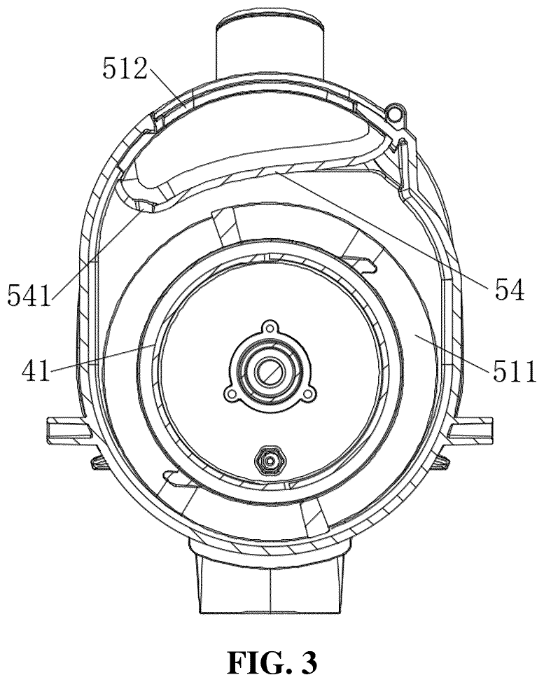

Referring to FIG. 2 and FIG. 3, the protective housing 323 is connected to the storage housing 51. A fixing portion 324 is provided at a junction between the protective housing 323 and the storage housing 51, so as to isolate the storage chamber 511, and prevent the liquid and the smoothie from entering the protective housing 323 to affect operation of the drive motor 321. The fixing portion 324 is provided vertically. In order to facilitate entry of the liquid from the feed clapboard 54 to the storage chamber 511, the feed clapboard 54 is provided obliquely. The feed hole 541 is formed in a lower position of the feed clapboard 54, such that the liquid poured into the feed clapboard 54 can flow downwardly into the feed hole 541 along the feed clapboard 54. The feed hole 541 is formed along a length direction of the evaporator 41 to form the elongated structure. Moreover, the liquid can flow to a surface of the evaporator 41 along the evaporator 41, and can immerse the surface of the evaporator 41 as uniformly as possible before entering the evaporator 41. Further, a longitudinal cross-section of the feed hole 541 is gradually increased from the fixing portion 324 to a direction away from the protective housing 323. This can guide more liquid to flow to a side of the evaporator 41 away from the protective housing 323. This not only can prevent much more liquid from impacting the fixing portion 324 to cause leakage to some extent, but also can flow the liquid to a middle surface of the evaporator 41 as quickly as possible. The fixing portion is preferably shaped as a convex ring.

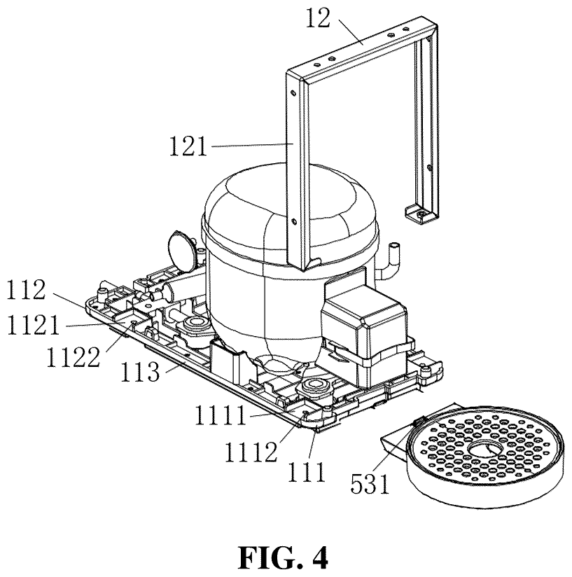

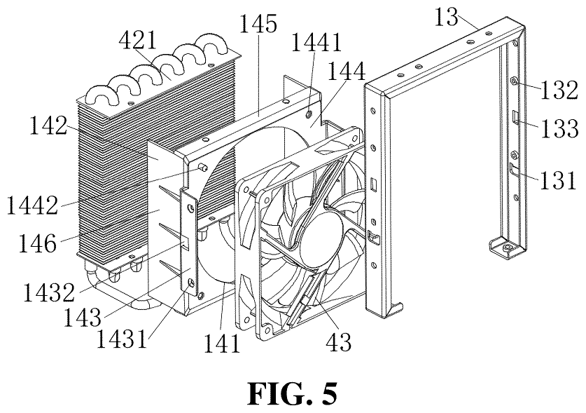

In addition, referring to FIG. 4 and FIG. 5, the refrigeration assembly 4 further includes a condenser 42 configured to remove heat dissipated after the liquid is iced. The fixation assembly 1 further includes a fixing frame 14. An air duct 141 is formed in the fixing frame 14. The fixing frame 14 is configured to fix the condenser 42. First vertical rods 121 are respectively provided at two sides of the first fixing rack 12. Second vertical rods 131 are respectively provided at two sides of the second fixing rack 13. The condenser 42 includes end plates 421. The end plates 421 are respectively provided at an upper side and a lower side of the condenser 42, and are fixed on the fixing frame 14. The fixing frame 14 is fixed on the second fixing rack 13.

In order to fix the fixing frame 14, vertical fixing plates 142 are respectively provided at two sides of the fixing frame 14. A convex fixing plate 143 is provided at a front side of the fixing vertical plate 142. A side of the convex fixing plate 143 close to the second fixing rack 13 is protruded. A frame fixing hole 1431 and a frame limiting fastener 1432 are provided on the convex fixing plate 143. A stud hole 132 and a frame limiting hole 133 are formed in the second vertical rod 131. The stud hole 132 corresponds to the frame fixing hole 1431. When the fixing frame 14 is mounted, the frame fixing hole 1431 can be fixed on the stud hole 132 with a fastener such as a bolt. Meanwhile, the frame limiting fastener 1432 can be buckled into the frame limiting hole 133 for limiting. This can further ensure the connection stability.

Referring to FIG. 5, the fixing frame 14 further includes a frame plate 144 and side baffles 146. The side baffles 146 are respectively provided at a left side and a right side of the frame plate 144, and extend away from the convex fixing plate 143. The side baffles 146 can be respectively attached to a left side and a right side of the condenser 42, such that the side baffles 146 enclose a heat dissipation channel. The air duct 141 is formed in the frame plate 144 and located in the heat dissipation channel. With the heat dissipation channel, heat dissipated by the condenser 42 can be removed smoothly. Condenser fixing plates 145 are respectively provided at an upper side and a lower side of the frame plate 144. The end plate 421 is fixed on the condenser fixing plate 145. The condenser fixed up and down is more stable than the condenser fixed left and right. The gravity of the condenser 42 is applied to the condenser fixing plate 145 through the end plate 421, and the condenser fixing plate 145 can apply a same counterforce. Even without the fastener such as the bolt, the condenser 42 can also be hung on the condenser fixing plate 145. For the condenser fixed left and right, although the frictional force can provide the counterforce, the frictional force is significantly different from the gravity of the condenser 42, and the condenser must be fixed depending on a locking force provided by the fastener such as the bolt. Therefore, the condenser 42 fixed vertically is connected more stably, and mounted more easily. For ease of heat dissipation, a side of the frame plate 144 away from the condenser 42 is provided with a fan fixing hole 1441 and a fan limiting post 1442. The refrigeration assembly 4 further includes a cooling fan 43. The cooling fan 43 can be inserted into the fan limiting post 1442 and fixed on the fan fixing hole 1441.

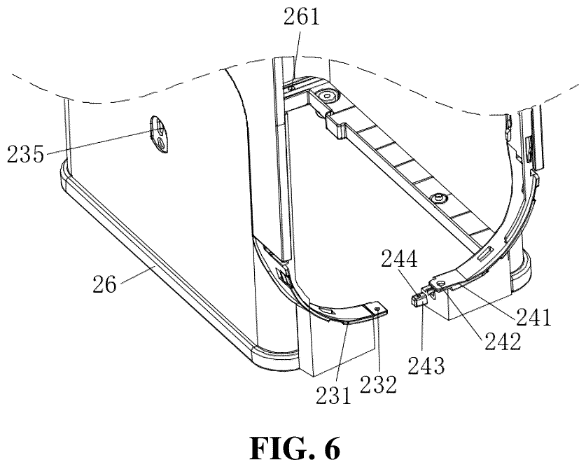

Referring to FIG. 6, in order to fix the first side vertical plate 23 and the second side vertical plate 24, a support flange 113 is provided at an edge of the chassis 11. The support flange 113 is protruded from an outer sidewall of the chassis 11. Support pedestals 26 are respectively provided at an inner bottom of the first side vertical plate 23 and an inner bottom of the second side vertical plate 24. After the first side vertical plate 23 and the second side vertical plate 24 are mounted, the first side vertical plate 23 and the second side vertical plate 24 can cover a left side and a right side of the chassis 11 to hide the chassis 11. A bottom fixing hole 261 is formed in the support pedestal 26. A bottom of the support flange 113 can abut against the support pedestal 26. The support pedestal 26 supports the support flange 113. The chassis 11 can be fixed in the bottom fixing hole 261.

In order that the first side vertical plate 23 and the second side vertical plate 24 are connected to form an integral structure, a first vertical plate support portion 231 is provided at an inner side of the first side vertical plate 23. The first vertical plate support portion 231 is protruded toward the second side vertical plate 24 to form a “J” shape. A first connecting hole 232 is formed vertically in the first vertical plate support portion 231. A second vertical plate support portion 241 is provided at an inner side of the second side vertical plate 24. The second vertical plate support portion 241 is protruded toward the first side vertical plate 23 to form a reverse “J” shape. The first vertical plate support portion 231 and the second vertical plate support portion 241 extend to each other. A second connecting hole 242 is formed vertically in the second vertical plate support portion 241. The first connecting hole 232 corresponds to the second connecting hole 242. With the fastener such as the bolt, the first connecting hole 232 and the second connecting hole 242 can be connected at the same time.

Further, in order to improve the connection strength, a side limiting hole 233 formed horizontally and a first side fixing hole 234 formed vertically are further provided in the first vertical plate support portion 231. The side limiting hole 233 and the first side fixing hole 234 communicate with each other. A side limiting bump 243 is further provided horizontally in the second vertical plate support portion 241. A second side fixing hole 244 is vertically formed in and penetrates the side limiting bump 243. When the first side vertical plate 23 and the second side vertical plate 24 are connected, the side limiting bump 243 can be inserted into the side limiting hole 233. The first side fixing hole 234 corresponds to the second side fixing hole 244. After the side limiting bump is inserted into the side limiting hole, the first side fixing hole 234 and the second side fixing hole 244 are connected with the fastener such as the bolt. In cooperation with the first connecting hole 232 and the second connecting hole 242, the first vertical plate support portion 231 and the second vertical plate support portion 241 can be limited at the same time in a horizontal direction and a vertical direction, thereby improving the connection strength. With the insertion design in which the side limiting bump 243 is inserted into the side limiting hole 233, the side limiting bump 243 can also be hidden to improve the integrity.

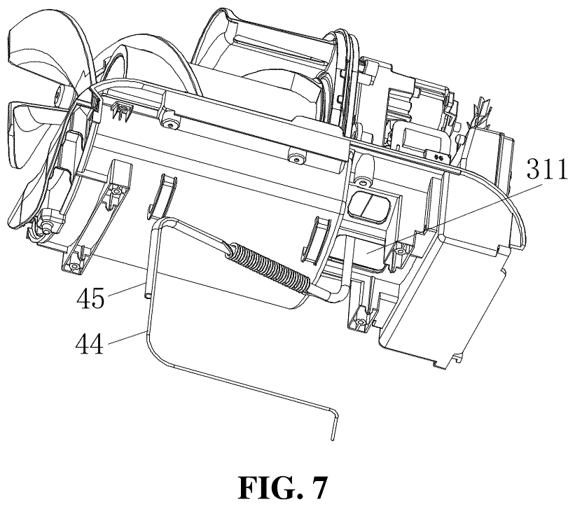

Further, referring to FIG. 7, the refrigeration assembly 4 further includes a throttle tube 44 and an air return tube 45. The throttle tube 44 is configured to throttle a condensed refrigerant to reduce a pressure, such that the refrigerant is evaporated in the evaporator 41. A compressor communicates with an inlet of the condenser 42. The condenser 42 communicates with the evaporator 41 through the throttle tube 44. The evaporator 41 communicates with the compressor through the air return tube 45. In order to facilitate tubing, and save an occupied space of a copper tube to adapt to a small volume space, the throttle tube 44 is arranged along the air return tube 45. Due to a small diameter of the throttle tube 44, the throttle tube 44 and the air return tube 45 can share the tubing space. A middle section of the throttle tube 44 is fixed on a middle section of the air return tube 45 in a winding manner. This can fix the throttle tube 44, and can omit the fixture and additional fixing space for the throttle tube 44.

Referring to FIG. 7, a heat dissipation hole 311 is formed in a bottom of the support rack 31. The heat dissipation hole 311 is located under the drive motor 321. The heat dissipation hole 311 is configured to dissipate heat of the drive motor 321. With the heat dissipation hole 311, both the air return tube 45 and the throttle tube 44 pass through the heat dissipation hole 311 downwardly from one end of the evaporator 41. The heat dissipation hole 311 not only can serve to dissipate the heat, but also provides a tubing space for the air return tube 45 and the throttle tube 44.

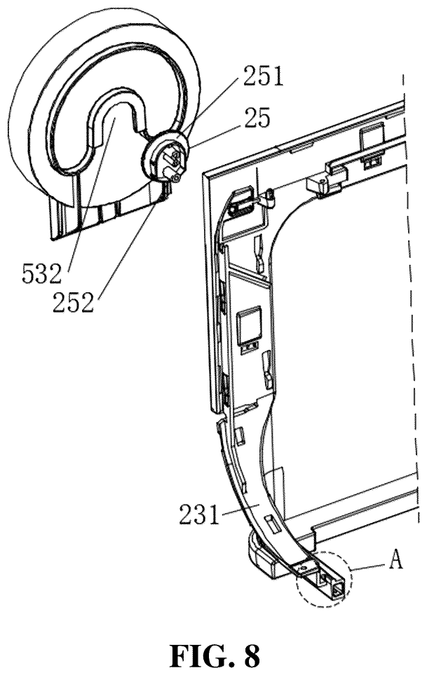

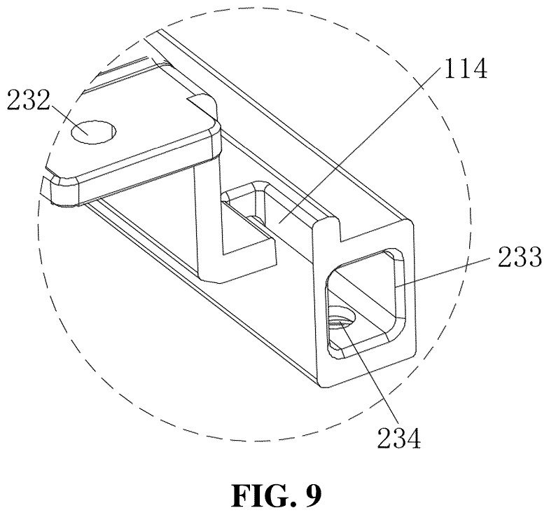

Referring to FIG. 4, FIG. 8 and FIG. 9, a bracket 53 is further provided under the discharge cartridge 52. A front connecting hook 531 is provided at one side of the bracket 53. A front side of the first vertical plate support portion 231 and the second vertical plate support portion 241 is provided with a front connecting groove 245. The front connecting hook 531 can be inserted into the front connecting groove 245. The bracket 53 is configured to support a smoothie container. Further, in order to make the whole slush machine more aesthetically-pleasing and further shorten the length of the slush machine, the bracket 53 can be collapsed to the first side vertical plate 23 or the second side vertical plate 24. Specifically, a hanger connecting hole 235 is further formed in a side of the first side vertical plate 23 and/a side of the second side vertical plate 24. The enclosure assembly 2 further includes a hanger 25. The hanger 25 includes one side provided with a hanging plate 251, and the other side provided with a connecting bump 252. The connecting bump 252 is protruded from the hanging plate 251, and can be inserted into the hanger connecting hole 235 to form a fixed connection. A slot 532 is formed in a bottom of the bracket 53. An opening of the slot 532 is provided downwardly. The connecting bump 252 can be inserted into the slot 532, such that the bracket 53 can be hung at the side of the first side vertical plate 23 and/the side of the second side vertical plate 24 to shorten the length of the slush machine, and reduce the footprint of the slush machine.

The above are merely preferred implementations of the present disclosure. It should be noted that a person of ordinary skill in the art may further make several improvements and modifications without departing from the principle of the present disclosure. These improvements and modifications should fall within the protection scope of the present disclosure.

1. A slush machine, comprising a stirring assembly, a refrigeration assembly, and a discharge assembly, wherein the stirring assembly comprises a support rack and a stirring mechanism provided on the support rack; the stirring mechanism comprises a protective housing, a drive motor, and a scraper; the refrigeration assembly comprises an evaporator; the evaporator is provided on the support rack; the drive motor is connected to the scraper through the evaporator; and the protective housing is sleeved on the drive motor; and
the discharge assembly comprises a storage housing and a discharge cartridge; the storage housing is provided horizontally; a storage chamber is formed in the storage housing; the discharge cartridge is provided vertically and communicates with the storage chamber; the storage housing is fixed on the support rack; the evaporator and the scraper are located in the storage chamber; a feed inlet is formed in the storage housing; a feed clapboard is provided under the feed inlet; and an elongated feed hole is formed in the feed clapboard.

2. The slush machine according to claim 1, wherein the protective housing is connected to the storage housing; a fixing portion is provided at a junction between the protective housing and the storage housing; the fixing portion is provided vertically; the feed clapboard is provided obliquely; the feed hole is formed in a lower position of the feed clapboard; the feed hole is formed along a length direction of the evaporator; and a longitudinal cross-section of the feed hole is gradually increased from the fixing portion to a direction away from the protective housing.

3. The slush machine according to claim 2, further comprising a fixation assembly and an enclosure assembly, wherein the fixation assembly comprises a chassis as well as a first fixing rack and a second fixing rack provided on the chassis; the enclosure assembly comprises a front vertical plate, a rear vertical plate, a first side vertical plate, and a second side vertical plate surrounding a periphery of the chassis; and the first fixing rack and the second fixing rack are respectively located at a bottom of a front end and a bottom of a rear end of the support rack, and are fixedly connected to the support rack.

4. The slush machine according to claim 3, wherein the refrigeration assembly further comprises a condenser; the fixation assembly further comprises a fixing frame; the fixing frame is provided at a side of the second fixing rack; an air duct is formed in the fixing frame; first vertical rods are respectively provided at two sides of the first fixing rack; second vertical rods are respectively provided at two sides of the second fixing rack; the condenser comprises end plates; the end plates are respectively provided at an upper side and a lower side of the condenser, and are fixed on the fixing frame; and the fixing frame is fixed on the second fixing rack.

5. The slush machine according to claim 4, wherein vertical fixing plates are respectively provided at two sides of the fixing frame; a convex fixing plate is provided at a front side of the fixing vertical plate; a side of the convex fixing plate close to the second fixing rack is protruded; a frame fixing hole and a frame limiting fastener are provided on the convex fixing plate; a stud hole and a frame limiting hole are formed in the second vertical rod; the stud hole corresponds to the frame fixing hole; and the frame limiting fastener is buckled into the frame limiting hole.

6. The slush machine according to claim 4, wherein the fixing frame further comprises a frame plate and side baffles; the side baffles are respectively provided at a left side and a right side of the frame plate, and extend away from the convex fixing plate; the side baffles enclose a heat dissipation channel; condenser fixing plates are respectively provided at an upper side and a lower side of the frame plate; the end plate is fixed on the condenser fixing plate; a side of the frame plate away from the condenser is provided with a fan fixing hole and a fan limiting post; the refrigeration assembly further comprises a cooling fan; and the cooling fan is inserted into the fan limiting post and fixed on the fan fixing hole.

7. The slush machine according to claim 3, wherein a support flange is provided at an edge of the chassis; the support flange is protruded from an outer sidewall of the chassis; support pedestals are respectively provided at an inner bottom of the first side vertical plate and an inner bottom of the second side vertical plate; a bottom fixing hole is formed in the support pedestal; a bottom of the support flange abuts against the support pedestal; and the chassis is fixed in the bottom fixing hole.

8. The slush machine according to claim 3, wherein a first vertical plate support portion is provided at an inner side of the first side vertical plate; the first vertical plate support portion is protruded toward the second side vertical plate; a first connecting hole is formed vertically in the first vertical plate support portion; a second vertical plate support portion is provided at an inner side of the second side vertical plate; the second vertical plate support portion is protruded toward the first side vertical plate; a second connecting hole is formed vertically in the second vertical plate support portion; and the first connecting hole corresponds to the second connecting hole.

9. The slush machine according to claim 8, wherein a side limiting hole formed horizontally and a first side fixing hole formed vertically are further provided in the first vertical plate support portion; a side limiting bump is further provided horizontally in the second vertical plate support portion; a second side fixing hole is vertically formed in and penetrates the side limiting bump; the side limiting bump is inserted into the side limiting hole; and the first side fixing hole corresponds to the second side fixing hole.

10. The slush machine according to claim 1, wherein the refrigeration assembly further comprises a throttle tube and an air return tube; a compressor communicates with an inlet of a condenser; the condenser communicates with the evaporator through the throttle tube; the evaporator communicates with the compressor through the air return tube; the throttle tube is arranged along the air return tube; and a middle section of the throttle tube is fixed on a middle section of the air return tube in a winding manner; and
a heat dissipation hole is formed in a bottom of the support rack; the heat dissipation hole is located under the drive motor; and both the air return tube and the throttle tube pass through the heat dissipation hole downwardly from one end of the evaporator.

11. The slush machine according to claim 8, wherein a bracket is further provided under the discharge cartridge; a front connecting hook is provided at one side of the bracket; a front side of the first vertical plate support portion and the second vertical plate support portion is provided with a front connecting groove; the front connecting hook is inserted into the front connecting groove; the bracket is configured to support a smoothie container; a hanger connecting hole is further formed in a side of the first side vertical plate and/or a side of the second side vertical plate; the enclosure assembly further comprises a hanger; the hanger comprises one side provided with a hanging plate, and the other side provided with a connecting bump; the connecting bump is protruded from the hanging plate, and inserted into the hanger connecting hole; a slot is formed in a bottom of the bracket; an opening of the slot is provided downwardly; and the connecting bump is inserted into the slot.
